(19) United States
(12) Patent Application Publication
(10) Pub. No.: US 2009/0277342 A1
(43) Pub. Date: Nov. 12, 2009

(54) OZONE TREATING SYSTEM AND METHOD

(76) Inventor: John P. Jetton, Flowery Branch, GA (US)

Correspondence Address: BLACK LOWE & GRAHAM, PLLC, 701 FIFTH AVENUE, SUITE 4800, SEATTLE, WA, 98104, US

(21) Appl. No.: 12/117,577

(22) Filed: May 8, 2008

(51) Int. Cl. A23L 3/3454

(52) U.S. Cl. 99/536

(57) ABSTRACT

The present invention generally relates to systems and processes for treating food items with ozone water, particularly including the application of ozone either after cooking or before cooling. In one example, a food item is cooked or heated at a first processing station and then transferred to a second station where it may be cooled or packaged. In some cases, particularly in large processing facilities, the food item is transferred from the first station to the second station by a conveyor belt. An ozone water distributor is positioned to spray the food item with ozone water as it travels along the belt from the first station to the second station.

### FIELD OF THE INVENTION

This invention relates generally to systems and methods for treating food with ozone.

### BACKGROUND OF THE INVENTION

Food processing facilities must be kept extremely clean in order to ensure a safe and clean final product. The United States Department of Agriculture (USDA) strictly enforces regulations requiring meat-processing and other food handling facilities to maintain proper cleanliness. On-site inspectors will often verify compliance by evaluating both the presence of microbes and the aesthetic appearance of a plant.

The desire for cleanliness applies to the food items themselves as well as the processing equipment. It is common to wash or rinse food items as a step during processing, though the washing or rinsing step occurs early in the process. For example, raw meat products may be rinsed at some point prior to cooking. As a general rule, however, rinsing or washing of food items during processing does not occur after cooking because the act of rinsing or washing a cooked food item during processing is generally considered to encourage bacteria growth.

Despite the foregoing, however, the inventor has found that rinsing food with ozone-water at later stages in the process can produce some surprising results. For food items that are cooked, rinsing them with ozone-water after cooking or before cooling or packaging brings the unexpected result of discouraging bacteria growth while increasing the food item's ultimate weight or yield when it is ready for consumption or sale.

### SUMMARY OF THE INVENTION

The present invention generally relates to systems and processes for treating food items with ozone. In one preferred form, a food item is cooked or heated at a first processing station and then transferred to a second station where it may be cooled (including refrigeration or freezing) or packaged. In some cases, particularly in large processing facilities, the food item is transferred from the first station to the second station by a conveyor belt. An ozone-water distributor is positioned to spray the food item with ozone water as it travels along the belt from the first station to the second station.

In several variations of the above example of the invention, the food items are sprayed with ozone water at different locations, either with or without a conveyor belt. For example, the food items may be sprayed at the first processing station and then transferred to the second station. Alternatively, they may be sprayed upon arrival at the second station, or both at the first station and the second station.

In yet other examples, the first and second processing stations are not discrete separate locations that require the use of a conveyor belt, but rather are located more closely adjacent one another or even essentially in the same area.

In still further examples of the invention there is only one process, such as cooking, refrigeration, or freezing, with the application of an ozone water rinse occurring either before or after that single process.

In other examples of the invention, any number of additional processes may occur at various stages. For example, the food item may be cooked and then cut into pieces before being coated with ozone-water and cooled.

In another version of the invention, the food item is sprayed with ozone-water after emerging from a refrigeration or freezing process. Further preferred aspects of the various examples of the invention are described below.

### BRIEF DESCRIPTION OF THE DRAWINGS

Preferred and alternative embodiments of the present invention are described in detail below with reference to the following drawings.

FIG. 1 is an illustration of a preferred ozone treating system;

FIG. 2 is a flow diagram of a preferred ozone treating process;

FIG. 3 is an illustration of an alternate preferred ozone treating system; and

FIG. 4 is an illustration of an alternate preferred ozone treating system.

### DETAILED DESCRIPTION OF THE PREFERRED EMBODIMENT

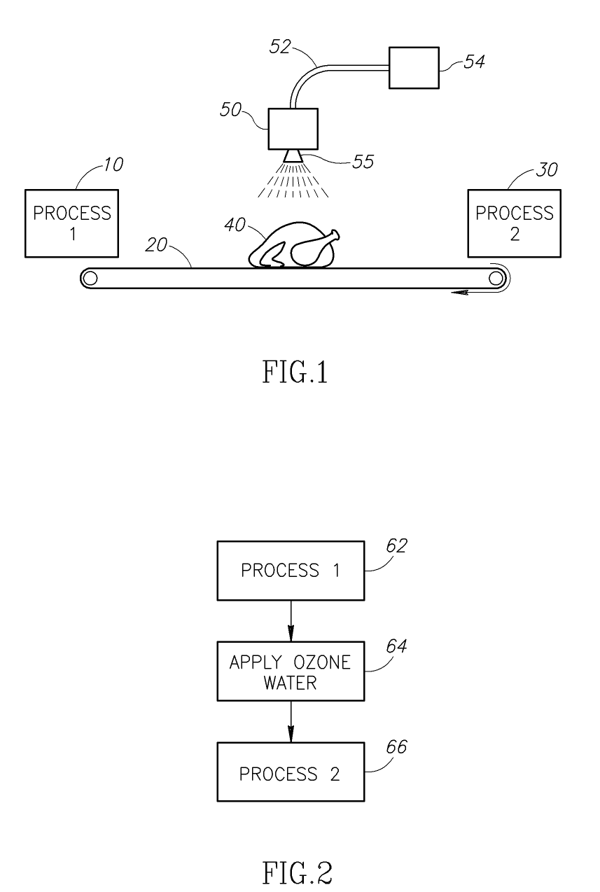

Referring to FIG. 1, a preferred example of the invention includes a first processing station 10 and a second processing station 30, with a conveyor 20 transporting food items 40 from the first station to the second station.

In one example, the first processing station 10 comprises an oven where food items are cooked or heated. Thus, meat products such as beef, fish or poultry may be cooked in an oven at the first station. Ideally the cooking or heating is conducted in an automated fashion in large processing facilities, employing timers and temperature sensors to ensure that the food item is fully cooked. In other forms, however, the cooking or heating may be performed in less sophisticated fashion such as in an ordinary oven or other heating source. Likewise, the food items may include vegetables or other non-meat products.

After heating or cooking, the food items may be transferred to the second processing station 30 where a second process occurs. The processes at the second station may include, for example, cooling, freezing, or packaging of the food item. In a preferred form, the food item such as poultry is cooked at the first station 10 and then transported by the conveyor belt 20 to the second processing station 30 where it is packaged or cooled. The step of cooling or freezing may occur either before or after packaging, as desired.

In the example as illustrated in FIG. 1 and discussed above, the food item 40 travels by conveyor 20 between the first and second processing stations. Though a conveyor is preferred, other structures may be used to transfer the food item between stations. As used in this specification, the term “conveyor” is used to generically refer to means of conveying the item from one location to another, while the term “conveyor belt” refers more specifically to a form of conveyance in which an endless belt continuously travels from one location to another. Thus, the conveyor may include (for example) a series of hooks for holding the food item, with each of the hooks connected to a chain or other means of conveying the chain from one location to another. At one or more points during the course of travel, the food item is rinsed by a spray of ozone water emanating from a spray head 50. As shown, the spray head 50 is connected to a hose 52 that leads to a source of ozone water 54.

In one preferred example of the invention, the ozone spray initially occurs at a point relatively closely adjacent an oven exit point. More particularly, in one example the first ozone sprayer after exiting the oven is provided in a region within six feet of travel on the conveyor after leaving the oven. In other examples the initial treating sprayer may be located more distant. In addition, in a preferred example of the invention there are multiple ozone sprayers provided along the length of the conveyor such that the food item being treated can be continually coated with ozone water along the path from oven to freezer or chiller, thereby ensuring at least some ozone in contact with the food item even as the ozone breaks down.

The ozone sprayer or spray head 50 may have one or more heads for spraying ozonated water across the conveyor belt. A spray bar with multiple heads is used in a preferred version of the embodiment to provide full coverage of the spray across the conveyor belt and ensure complete coating of the food item. Preferably, the sprayer includes one or more spray heads 50 emitting a jet of water at a coverage pattern from 10 to 110 degrees wide and at a rate of from 1 to 5 gallons per minute (gpm). The spray patterns of multiple heads on a spray bar may overlap to ensure complete coverage. The heads are typically located from 2 to 12 inches from the surface of the conveyor belt, or higher as appropriate depending on the size of the food items being treated.

In a preferred form, the spray head 50 or its nozzle 55 are oriented to direct the flow of ozone-water in a direction that is angled at approximately 45 degrees with respect to direction of travel of the conveyor. In other versions of the invention, the spray head is perpendicular to the conveyor, or at other angles to accomplish an effective coverage of the food item.

The ozonated water used typically has a temperature from 32 to 100 degrees F. The concentration of ozone within the ozonated water is chosen such that off-gas from the nozzles remains below safety thresholds. In the preferred form, at the point of impact with the conveyor belt, the ozonated water typically has an ozone concentration of from 1.0 to 3.5 parts per million (ppm). The pressure of the ozonated water is typically low in order to reduce the amount of off-gassing and retain ozone in the water when it meets the food item. Preferred pressures used may vary from 10 to 110 psi.

In some examples of the invention, the food item is cooked or heated at a first station 10 and then rinsed with ozone water as discussed above, but without application of a second process as illustrated in FIG. 1. Likewise, in this or any version of the invention, the application of ozone water need not be performed by using a spray bar or a conveyor. Though the conveyor and spray bar are particularly well-suited for large facility operations, ozone water may be applied on other ways. As one example, a hand-held sprayer may apply ozone water at any location, including at the first processing station.

In yet another example of the invention, the cooking or heating step may be omitted. Thus, for example, the food item may be treated with ozone water prior to a further processing step such as cooling, freezing, or packaging. In one form, the benefits of the invention are best realized by application of ozone water immediately prior to the step of cooling, freezing, or packaging.

It is also be desirable in some applications to apply an ozone spray to the food item after it exits the chiller or freezer. In such applications, it is preferred to apply the ozone spray within a short distance of the exit from the chiller or freezer, and preferably within the first ten feet of travel.

The ozone treating system may be used to perform an exemplary method as illustrated FIG. 2, in whole or in part. A food item is subjected to a first process in a first step 62, which may include cooking or heating. After an initial process, the food item is treated with ozone water in a second step 64. The step of treating with ozone water may occur in the same location or as the food item travels along a conveyor belt. In some examples of the invention, the food item is subjected to a second process at a third step 66. The second process may include, for example, refrigeration, freezing, packaging, or a combination of them.

In other versions of the invention, the first process 62 of FIG. 2 is refrigeration or freezing and the second process 66 is packaging. This version is explained in further detail with respect to FIG. 4 below.

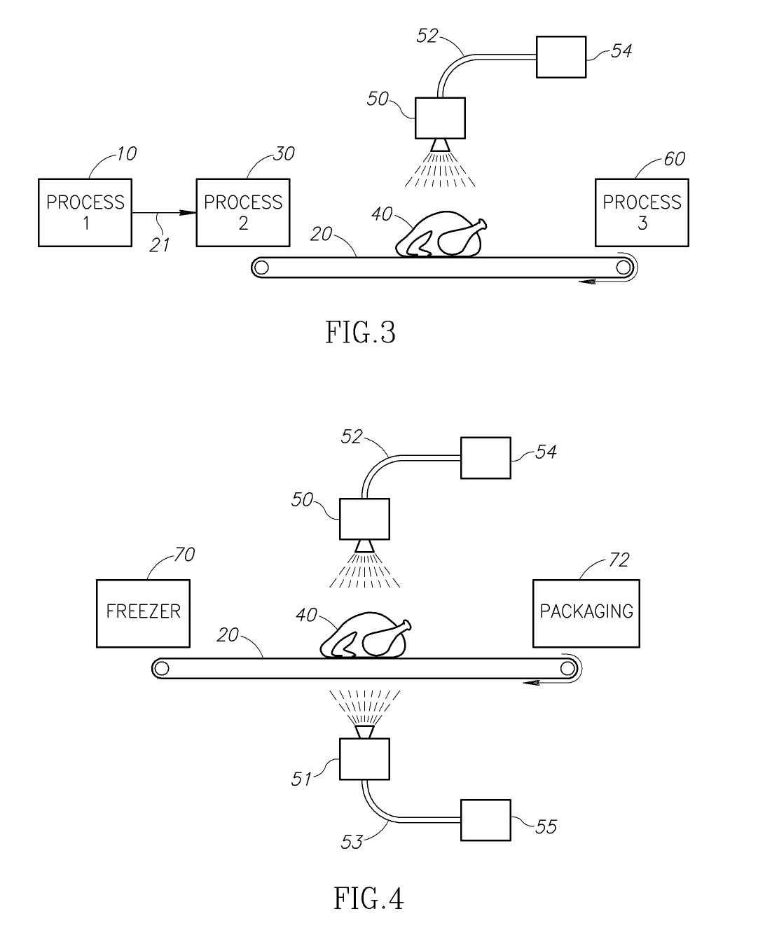

FIG. 3 illustrates an example of the invention in which multiple processing steps occur prior to spraying the food item with ozone-water. Thus, a first process such as cooking or heating occurs at a first processing station 10. A second process occurs at a second processing station 30. In one example, the second process may be cutting the food item or mixing it with other food items. As shown, the second station 30 is indicated as being separated from the first station 10 such that the food item is transported as indicated by the arrow 21 from the first station to the second station. The step of moving the food item may occur by a conveyor or other automated means, or may be manual. Likewise, the two processing steps are illustrated as occurring at separate stations separated from one another but may alternatively occur at a single location or at locations more closely adjacent one another.

After the second process, the food item 40 travels along the conveyor 20 (or alternate means such as discussed above) and is subjected to an ozone-water spray from one or more spray heads 50 connected to a source of ozone-water via a hose 52. An additional third process such as refrigeration or packaging may occur at a third station 60. Likewise, in one embodiment a third process comprises refrigeration and is followed by a fourth process of freezing.

FIG. 4 illustrates another preferred implementation in which the application of ozone-water occurs after a food item has been refrigerated or frozen. Although not shown, the food item 40 may be subjected to any number of prior processing steps such as cutting, cooking, heating, cooling, or others prior to freezing. As shown, the food item is frozen or stored in a freezer 70. Though referred to as a freezer in the present embodiment, the food item may be refrigerated at a temperature that may not amount to freezing.

The food item 40 exits the freezer via the conveyor 20 and travels via the conveyor toward a packaging station 72. As noted above, the conveyor may take any form and may alternatively be a manual means of conveyance or, in some versions, may be omitted altogether.

As the food item 40 travels on the conveyor, it is sprayed with an ozone-water spray via the spray head 50. In a preferred version, the food item is sprayed from both above and below the food item (and conveyor) and therefore the system includes an additional spray head 51 below the conveyor, with the additional spray head having a belt 53 connected to a source of ozone-water 55. Though one spray head is shown, any number of spray heads may be used above, below, or at the sides of the food item. Where a conveyor belt is used, the belt preferably is formed as a wire belt or otherwise contains sufficient pores to allow the ozone-water to readily flow through the belt to the food item 40.

In a preferred example of the arrangement of FIG. 4, the food item exits the freezer 70 at a temperature of 0 degrees Fahrenheit or colder and the ozone-water is at a temperature below 36 degrees, and preferably in the range of about 28 to 36 degrees F. In other embodiments the food item may be at higher temperatures and the ozone-water may be at a typical tap-water temperature of about 60 to 90 degrees. By using cold water in the range above and applying it to a food item at about 0 degrees, the ozone water will quickly freeze to the food item and form a thin frozen ozone-water film around the food item that should substantially remain in place during the packaging step.

In yet other variations of the invention, an ozone-water dip is used in place of or in addition to the ozone spray. In such embodiments, the food item is dipped into a container of ozone-water so that it is coated. The ozone dip is especially suited for use in the system of FIG. 4, when applied between freezing and packaging.

Finally, the food item reaches the packaging station 72 where it is packaged. Preferably, the ozone application occurs within 3 to 10 feet after the food item 40 leaves the refrigerator or freezer and the packaging step occurs in a brief period after application of ozone-water.

Contrary to conventional wisdom, a preferred example of the above system applies a water-based rinse to food items after heating or cooking. Rinsing food after heating or cooking is widely believed to be undesirable because the rinse water itself may encourage bacteria growth or introduce contaminants to the food item. The inventor has found, however, that the use of ozone water discourages bacteria growth. In addition, the inventor has found the surprising and unexpected result that rinsing food with ozone water after cooking or heating, or before cooling, freezing, or packaging increases the final weight, or yield, of the food item in most cases by two to four percent and perhaps more. Thus, applying an ozone rinse either after heating, just prior to cooling, or just prior to packaging provides an unexpected dual benefit of discouraging bacteria growth as well as increasing the yield of the food item.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A method for processing a food item comprising:
heating the food item at a first processing location; and
applying ozone water to the food item after heating the food item.

2. The method of claim 1, wherein the food item comprises a meat product.

3. The method of claim 1, wherein the food item comprises poultry.

4. The method of claim 1, wherein the step of heating the food item comprises cooking the food item.

5. The method of claim 1, further comprising cooling the food item after the step of applying ozone water.

6. The method of claim 5, wherein the step of cooling comprises freezing the food item.

7. The method of claim 5, wherein the step of cooling is performed at a second processing location.

8. The method of claim 7, wherein after the step of heating the food item is transferred from the first processing location to the second processing location, and further wherein the step of applying ozone water is performed while the food item is being transferred.

9. The method of claim 1, further comprising cooling the food item before the step of applying ozone water.

10. The method of claim 9, wherein the step of cooling comprises freezing the food item.

11. The method of claim 9, wherein the step of cooling is performed at a second processing location.

12. An ozone treating system, comprising:
a first processing station configured to heat a food item;
a second processing station;
a conveyor configured to transport the food item from the first processing station to the second processing station; and
a source of ozone water configured to deliver the ozone water to the food item at a location between the first processing station and the second processing station.

13. The system of claim 12, wherein the first processing station comprises an oven.

14. The system of claim 12, wherein the second processing station comprises a refrigerator.

15. The system of claim 12, wherein the conveyor comprises a conveyor belt.

16. The system of claim 12, wherein the source of ozone water further comprises a spray head configured to spray the food item with the ozone water.

17. The system of claim 12, wherein the spray head is directed toward the conveyor, whereby it is configured to spray the food item with the ozone water as the food item travels along the conveyor.

18. The system of claim 12, wherein the second processing station comprises a packaging station.

19. The system of claim 12, wherein the source of ozone water is configured to deliver the ozone water at a location within six feet of the first processing station.

20. The system of claim 12, wherein the source of ozone water is configured to deliver ozone water to the food item substantially continually along the path of travel between the first processing station and the second processing station.

21. A method for processing a food item comprising:
cooling the food item at a first processing location; and
applying ozone water to the food item after cooling the food item.

22. The method of claim 21, wherein the food item comprises a meat product.

23. The method of claim 21, wherein the food item comprises poultry.

24. The method of claim 21, wherein the step of cooling the food item comprises freezing the food item.

25. The method of claim 21, further comprising packaging the food item after the step of applying ozone water.

26. The method of claim 21, wherein after the step of cooling the food item is transferred from the first processing location to a second processing location, and further wherein the step of applying ozone water is performed while the food item is being transferred.

27. The method of claim 21, wherein the ozone water is applied at a temperature below about 36 degrees F. and the food item is at a temperature of about 0 degrees F. when the ozone water is applied.
